(19) United States
(12) Patent Application Publication
(10) Pub. No.: US 2008/0169641 A1
(43) Pub. Date: Jul. 17, 2008

(54) Inline irrigation pipe adapter fitting and method of installation

(76) Inventors: Cathy D. Santa Cruz, Reno, NV (US); William R. Armes, Sun Valley, NV (US)

Correspondence Address: Cathy D. Santa Cruz, 7630 Tholl Drive, Reno, NV, 89506, US

(21) Appl. No.: 11/653,698

(22) Filed: Jan. 16, 2007

(51) Int. Cl. F16L 41/03

(52) U.S. Cl. 285/5

(57) ABSTRACT

A pipe adapter fitting that can be installed onto any pre-existing conduit such as an underground irrigation line for installation of an additional water outlet for attaching a sprinkler head or the like. The pipe adapter fitting is extremely simplified, requires only two parts and eliminates the need for any screws, bolts, brackets, clamps, etc. Furthermore, there are no moving parts and no need for specialized tools as only a drill is used for installation.

### FIELD OF THE INVENTION

The present invention relates in general to pipe fittings that can be installed onto an underground irrigation line for installation of an additional water outlet for attaching a sprinkler head or the like. More particularly the invention pertains to a simplified pipe adapter fitting that requires only two parts and eliminates the need for any screws, brackets, clamps, etc. Furthermore, there are no moving parts and no need for specialized tools as only a drill is used for installation.

### BACKGROUND OF THE INVENTION

In many instances it is desirable to install an additional water outlet onto a pre-existing irrigation line after installation. For example, the initial irrigation line may have been limited to a specified lawn area and/or designed for a specific number of plants or trees. However, after installation the landowner determines that the landscaped area needs to be modified to allow for additional watering. Whereby, additional sprinkler heads or the like are then required. This is a common problem and heretofore the installation process requires numerous steps and specialized tools. For example, in every known prior art installation procedure the workman must dig a hole to expose a large section including the sides, top and bottom of the irrigation line so as to allow room for tools, etc. For example at least a foot on each side and below of the installation point is typically required. This is time consuming, laborious and not cost effective.

More importantly, the currently available pipe adapters are extremely complicated and include multiple parts such as clamps, brackets, bolts, nuts, screws, etc., all of which the present invention completely eliminates.

It is obvious that this is a problem that needs to be easily and cost effectively overcome as many attempts have been proposed, yet none have successfully resolved the issue such as exemplified within the following Patents.

U.S. Pat. Nos. 6,986,532, 6,907,896, 7,082,960, 4,329,265, 5,694,972, 5,105,844, 6,357,472 and 5,913,635. All of these references attempt to provide a pipe tee adapter of some type. Unfortunately, within the known prior art there has not been taught, suggested, or addressed the need for a simplified pipe adapter fitting that does not require specialized installation tools, and/or multiple parts that must be attached together by either, clamps, brackets, bolts, nuts, screws, etc. Thus, the present invention has been made simpler without loss of capability and includes only two parts that are easily installed and very cost effective to manufacture in a manner heretofore not taught.

### OBJECTS AND ADVANTAGES OF THE PRESENT INVENTION

It is therefore a primary object of the present invention to provide a new simplified pipe adapter fitting that is easily connectable onto a pre-existing irrigation line that allows for an additional water outlet for installation of a sprinkler or the like of which heretofore has not been taught, addressed or suggested.

It is another object of the present invention to provide a new simplified pipe adapter fitting that reduces the amount of earth that must be removed for installation when compared to the prior art. Thus the invention saves time and labor when compared to the prior art installation methods.

Still a further object of the present invention is to provide a new simplified pipe adapter fitting that is constructed of only two parts that are removably frictionally snapped together. The pipe adapter fitting has no moving parts and eliminates the need for any additional attachment means.

Yet another object of the present invention is to provide a new simplified pipe adapter fitting that is made from any suitable material of engineering choice, such as PVC pipe or the like. Furthermore, each of the two parts can be formed as one integral unit by plastic mold injection, or the like.

Still another object of the present invention is to provide a new simplified pipe adapter fitting that can be easily installed onto any type of pre-existing irrigation line or any other conduit of choice.

A further object of the present invention is to provide a new simplified pipe adapter fitting that is very cost effective to manufacture, sell, install and also various sizes of choice are optional.

Other objects and advantages will become apparent when taken into consideration of the following specification and drawings.

### BRIEF DESCRIPTION OF THE DRAWINGS

FIG. 1 is an overall plan view for installation of the present pipe adapter fitting when installing onto a pre-existing underground irrigation line.

FIG. 2 is a side view of the present invention when installed onto the irrigation line.

### DETAILED DESCRIPTION OF THE DRAWINGS

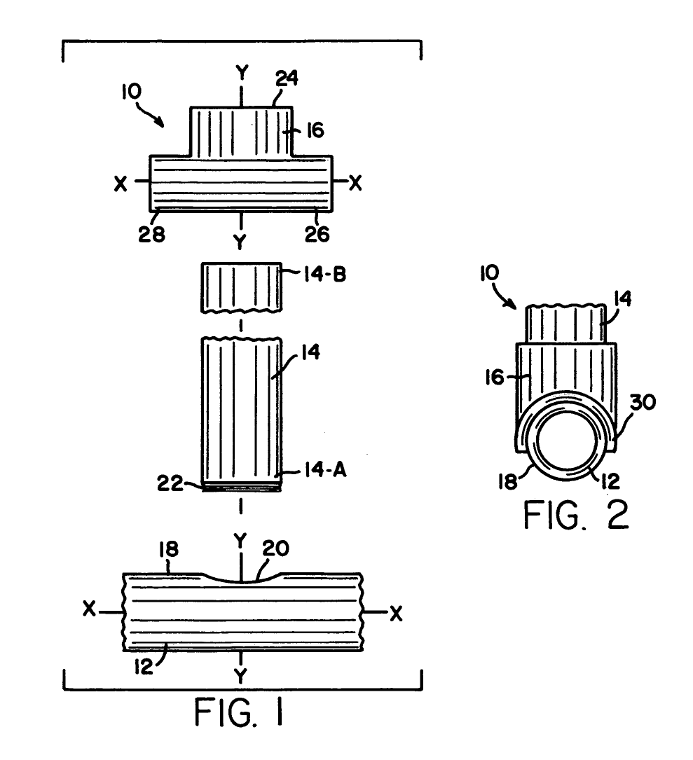

Referring now in detail to the drawings wherein like characters refer to like elements throughout the various views. As previously stated the present invention is an inline irrigation pipe adapter fitting represented by overview (10) as depicted in FIGS. 1 & 2 and is suitable for use in combination with a pre-existing conduit (12). It is to be noted the inline adapter fitting can be used for other adaptations pertaining to any pre-existing conduit (12). Thus the invention is not to be limited in use specifically for an irrigation line but for illustrative purposes the conduit as depicted herein is an irrigation line simply for exemplary purposes.

It is to be further noted the present invention can be made of any suitable material of choice and the pre-existing conduit can be of any material as well. However, for illustrative purposes the pre-existing conduit (12) and the pipe adapter fitting (10) as taught herein are made by plastic mold injection, typically referred to as PVC pipe.

Thus the overall general concept for the present invention includes a pre-existing conduit (12), an attachment pipe (14) and a pipe attachment flange (16). The preexisting conduit (12) includes a vertical Y-axis, a horizontal X-axis and a sidewall (18) extending along the horizontal X-axis. The sidewall (18) having an aperture (20) cut therein. It is to be understood the aperture (20) is cut at the time of installation by any suitable means such as a drill (not shown) or the like. The attachment pipe (14) includes a first end (14-A) and a second end (14-B) and the first end (14-A) is of a shape and size to be inserted into aperture (20) and attached thereto by any suitable attachment means of engineering choice, such as by a friction fit, threads (22) or the like. It is to be noted for reduction of leakage and a more secure attachment the workman may also apply pipe cement (not shown) onto the first end (14-A) if required.

The pipe attachment flange (16) includes a Y-axis and an X-axis as depicted in FIG. 1. The pipe attachment flange (16) further includes a circular bore (24) there through along said Y-axis, a first outwardly extending end (26) along the X-axis and a second outwardly extending end (28) along the X-axis. Each outwardly extending end (26 & 28) being opposed to each other and in combination form an upside down elongated C-shaped receptacle (30) more clearly shown in FIG. 2. The upside down elongated C-shaped receptacle (30) being in open communication with the circular bore (24). It is to be noted for reduction of leakage and a more secure attachment the workman may also apply pipe cement (not shown) onto the inside surface of the upside down elongated C-shaped receptacle if required. Whereby, during installation the pipe attachment flange (16) can be slidably downwardly engaged over the attachment pipe (14) and onto the pre-existing conduit (12). Thus resulting in the elongated C-shaped receptacle (30) having a mating relationship with the sidewall (20). Whereby, the pipe attachment flange (16) is frictionally retained onto the preexisting conduit (12) and provides support for the attachment pipe (14). Therefore the installation process is extremely simple as no additional tools, brackets, screws, bolts, or the like are required as a friction fit is most efficient and provides a strong attachment and support means.

As previously noted the present invention also teaches a simplified installation method as exemplified in the following paragraph illustrating the method steps.

It is to be understood that the general method of installation is again adaptable for use with any pre-existing conduit such as follows:

A method for installing an inline pipe adapter fitting (10) onto a pre-existing conduit (12) comprising the steps of:

The first step includes locating a pre-existing conduit (12) having a sidewall (18). As previously noted the pre-existing conduit (12) maybe an underground irrigation line or the like. The second step includes determining a desired location for installing the pipe adapter fitting (10) onto the sidewall (18). For example if the pipe adapter fitting (10) is to be used for attachment onto a sprinkler head (not shown), the workman determines the position of choice for the sprinkler and digs an inline vertical hole at that point until locating the conduit. Thereafter the workman removes enough earth to expose a sufficient area for further installation. The fourth step includes drilling a hole (20) into the sidewall (18) at the desired location. It is to be noted for reduction of leakage and a more secure attachment the workman may also apply pipe cement (not shown) onto the first end (14-A) if required before performing the next step which is inserting the attachment pipe (14) into the hole (20). Again it is to be understood the attachment pipe can be attached by any suitable attachment means such as by a friction fit, or threads (22) or the like. It is to be noted for reduction of leakage and a more secure attachment the workman may also apply pipe cement (not shown) onto the inside surface of the upside down elongated C-shaped receptacle if required before performing the next step. The final step includes positioning the pipe attachment flange (16) above the attachment pipe (14) and then the workman presses downwardly and slidably engages the pipe attachment flange (16) onto the attachment pipe (14) until the pipe attachment flange (16) engages onto the sidewall (18) in a mating relationship. Whereby the pipe attachment flange (16) and the attachment pipe (14) are now fixedly attached onto the pre-existing conduit (12).

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

Having described our invention, what we claim as new and desire to secure by Letters Patent is:

1. An inline pipe adapter fitting for use in combination with a pre-existing conduit comprising: a pre-existing conduit; an attachment pipe; and a pipe attachment flange; said pre-existing conduit having a vertical Y-axis, a horizontal X-axis and a sidewall extending along said horizontal X-axis, said sidewall having an aperture cut therein, said attachment pipe having a first end and a second end, said first end being inserted into said aperture and attached thereto by attachment means, said pipe attachment flange having a Y-axis and an X-axis, said pipe attachment flange having a circular bore there through along said Y-axis, said pipe attachment flange having a first outwardly extending end along said X-axis and a second outwardly extending end along said X-axis, each said outwardly extending end being opposed to each other, each said outwardly extending end in combination form an upside down elongated C-shaped receptacle, said upside down elongated C-shaped receptacle being in open communication with said circular bore, said pipe attachment flange being slidably downwardly engaged over said attachment pipe and onto said pre-existing conduit, resulting in said elongated C-shaped receptacle having a mating relationship with said sidewall, whereby said pipe attachment flange is frictionally retained onto said pre-existing conduit and provides support for said attachment pipe.

2. The inline pipe adapter fitting for use in combination with a pre-existing conduit of claim 1 wherein said attachment means is a friction fit.

3. The inline pipe adapter fitting for use in combination with a pre-existing conduit of claim 1 wherein said attachment means is threads.

4. The inline pipe adapter fitting for use in combination with a pre-existing conduit of claim 1 wherein said pipe attachment flange is integrally formed by plastic mold injection.

5. The inline pipe adapter fitting for use in combination with a pre-existing conduit of claim 1 wherein said pre-existing conduit is an underground irrigation line.

6. A method for installing an inline pipe adapter fitting onto a pre-existing conduit comprising the steps of:
a. locating a pre-existing conduit, said pre-existing conduit having a sidewall;
b. determining a desired location for installing a pipe adapter fitting onto said sidewall;
c. drilling a hole into said sidewall at said desired location;
d. inserting an attachment pipe into said hole;
e. positioning a pipe attachment flange above said attachment pipe; and;
pressing downwardly and slidably engaging said pipe attachment flange onto said attachment pipe until said pipe attachment flange engages onto said sidewall in a mating relationship, whereby said pipe attachment flange and said attachment pipe are fixedly attached onto said pre-existing conduit.

7. A method for installing an inline pipe adapter fitting onto a pre-existing conduit comprising the steps of:
a. locating a pre-existing conduit, said pre-existing conduit having a sidewall;
b. determining a desired location for installing a pipe adapter fitting onto said sidewall;
c. drilling a hole into said sidewall at said desired location;
d. applying pipe cement onto an attachment end of an attachment pipe;
e. inserting said attachment pipe into said hole;
f. grasping a pipe attachment flange, said pipe attachment flange having an upside down elongated C-shaped receptacle;
g. applying pipe cement onto the inside surface of said upside down elongated C-shaped receptacle;
h. positioning said pipe attachment flange above said attachment pipe; and;
i. pressing downwardly and slidably engaging said pipe attachment flange onto said attachment pipe until said pipe attachment flange engages onto said sidewall in a mating relationship, whereby said pipe attachment flange and said attachment pipe are fixedly attached onto said pre-existing conduit.
